(19) United States
(12) Patent Application Publication
(10) Pub. No.: US 2026/0037507 A1
(43) Pub. Date: Feb. 5, 2026

(54) Metro-Level Distributed Caching

(71) Applicant: Google LLC, Mountain View, CA (US)

(72) Inventors: Catalin Vlas, Zurich (CH); Janne Tapio Kulmala, Zurich (CH); Nikolas Ioannou, Zurich (CH)

(73) Assignee: Google LLC, Mountain View, CA (US)

(21) Appl. No.: 18/792,515

(22) Filed: Aug. 1, 2024

(51) Int. Cl. G06F 16/2453; G06F 16/25

(52) U.S. Cl. CPC G06F 16/24539; G06F 16/25

(57) ABSTRACT

A distributed computing system includes a non-designated and a designated computing system. The non-designated system is configured to: receive a first data request from a user device requesting first data; determine that the first data is not stored in a first cache at the non-designated system; based on determining the first data is not stored in the first cache, send a second data request to the designated system including a request for the first data; receive the first data from the designated system; send the first data to the user device; and store the first data in the first cache. The designated system is configured to: determine that the first data is stored in a second cache at the designated system and, based on the first data being stored in the second cache, send the first data to the non-designated system.

### TECHNICAL FIELD

This disclosure relates to metro-level distributed caching.

### BACKGROUND

Some distributed computing systems employ local caching to reduce the computational costs, network costs, and/or latencies associated with accessing a backend database. In some examples, distributed computing systems are used to serve data associated with extremely large or global collections of audio and/or video files. In such systems, each particular computing system (i.e., data server) of the distributed computing system typically implements a local cache that stores data recently and/or frequently accessed by users of each particular computing system.

### SUMMARY

One aspect of the disclosure provides a system that includes a backend database configured to store data, and a distributed computing system. The distributed computing system includes a plurality of communicatively-coupled computing systems in communication with the backend database. The plurality of computing systems include a non-designated computing system and a designated computing system. The designated computing system is a peer of the non-designated computing system. The non-designated computing system is configured to receive a first data request from a user device that includes a request for first data stored in the backend database, determine that the first data is not stored in a first cache at the non-designated computing system, based on determining that the first data is not stored in the first cache, send a second data request that includes a request for the first data stored in the backend database to the designated computing system, receive the first data from the designated computing system, send the first data to the user device, and store the first data in the first cache. The designated computing system is configured to determine that the first data is stored in a second cache at the designated computing system and, based on determining that the first data is stored in the second cache, send the first data to the non-designated computing system.

Implementations of the disclosure may include one or more of the following optional features. In some implementations, the non-designated computing system is further configured to receive a third data request from a second user device that includes a request for second data stored in the backend database and determine that the second data is stored in the first cache. Based on determining that the second data is stored in the first cache, the non-designated computing system is also configured to send the second data to the designated computing system and send the second data to the second user device.

In some examples, the non-designated computing system is further configured to receive a third data request from a second user device that includes a request for second data stored in the backend database and determine that the second data is not stored in the first cache. The non-designated computing system configured to, based on determining that the second data is not stored in the first cache, send a fourth data request to the designated computing system that includes a request for the second data stored in the backend database, and receive the second data from the designated computing system. Here, the designated computing system is further configured to determine that the second data is not stored in the second cache and, based on determining that the second data is not stored in the second cache send a fifth data request to a backend database server associated with the backend database that includes a request for the second data stored in the backend database, and receive the second data from the backend database server. The designated computing system is further configured to send the second data to the non-designated computing system. In some implementations, the non-designated computing system is further configured to store the second data in the first cache, and the designated computing system is further configured to store the second data in the second cache.

In some implementations, the designated computing system is configured to receive a third data request from a second user device that includes a request for second data stored in the backend database and determine that the second data is not stored in the second cache. The designated computing system configured to, based on determining that the second data is not stored in the second cache send a fourth data request to a backend database server associated with the backend database that includes a request for the second data stored in the backend database, receive the second data from the backend database server, and store the second data in the second cache. The designated computing system is further configured to send the second data to the second user device.

In some examples, the designated computing system is further configured to receive a third data request from a second user device that includes a request for second data stored in the backend database, determine that the second data is stored in the second cache, based on determining that the second data is stored in the second cache, and send the second data to the second user device. In some implementations, the designated computing system is further configured to refresh a status of the second data in the second cache.

In some implementations, the plurality of communicatively-coupled computing systems are geographically located within a same metropolitan area. In some examples, each computing system of the plurality of computing systems includes one or more of: a physical computing resource, a virtual computing resource, or a data center that includes a plurality of computing resources. In some implementations, each computing system of the plurality of computing systems includes a selection module configured to collectively select a first computing system of the plurality of computing systems as the designated computing system.

Another aspect of the disclosure provides a computer-implemented method that, when executed on data processing hardware of a distributed computing system, causes the data processing hardware to perform operations. The operations include receiving, at a first computing system of the distributed computing system, a first data request from a user device that includes a request for first data stored in a backend database, the backend database in communication with the distributed computing system, and determining, by the first computing system, that the first data is not stored in a first cache at the first computing system. The operations also include, based on determining that the first data is not stored in the first cache, sending, from the first computing system, a second data request to a second computing system of the distributed computing system that includes a request for the first data stored in the backend database, and, based on the second computing system determining that the first data is stored in a second cache at the second computing system, receiving, at the first computing system, the first data from the second computing system. The operations further include sending, from the first computing system, the first data to the user device, and storing, by the first computing system, the first data in the first cache.

Implementations of the disclosure may include one or more of the following optional features. In some implementations, the operations also include receiving, at the first computing system, a third data request from a second user device that includes a request for second data stored in the backend database, and determining, by the first computing system, that the second data is stored in the first cache. Based on determining that the second data is stored in the first cache, the operations also include sending, from the first computing system, the second data to the second computing system, and the second data to the second user device.

In some examples, the operations also include receiving, at the first computing system, a third data request from a second user device that includes a request for second data stored in the backend database, and determining, by the first computing system, that the second data is not stored in the first cache. Based on determining that the second data is not stored in the first cache, the operations include sending, from the first computing system, a fourth data request to the second computing system that includes a request for the second data stored in the backend database. Here, when the second data is not stored in the second cache, the second computing system is configured to send a fifth data request to a backend database server associated with the backend database that includes a request for the second data stored in the backend database, receive the second data from the backend database server, and send the second data to the first computing system. In some implementations, the operations also include storing, by the first computing system, the second data in the first cache, wherein second computing system is configured to store the second data in the second cache.

In some implementations, the second computing system is further configured to receive a third data request from a second user device that includes a request for second data stored in the backend database, and determine that the second data is not stored in the second cache. Based on determining that the second data is not stored in the second cache, the second computing system is also configured to send a fourth data request to a backend database server associated with the backend database that includes a request for the second data stored in the backend database, receive the second data from the backend database server, store the second data in the second cache, and send the second data to the second user device.

In some examples, the second computing system is further configured to receive a third data request from a second user device that includes a request for second data stored in the backend database, and determine that the second data is stored in the second cache. Based on determining that the second data is stored in the second cache, the second computing system is also configured to send the second data to the second user device. In some implementations, the second computing system is further configured to refresh a status of the second data in the second cache.

In some implementations, the plurality of communicatively-coupled computing systems are geographically located within a same metropolitan area. In some examples, each computing system of the plurality of computing systems includes one or more of: a physical computing resource, a virtual computing resource, or a data center that includes a plurality of computing resources. In some implementations, each computing system of the plurality of computing systems includes a selection module configured to collectively select a first computing system of the plurality of computing systems as the designated computing system.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example distributed computing system for performing metro-level distributed caching.

FIG. 2 is a sequence diagram of example operations of a distributed computing system for performing metro-level distributed caching.

FIG. 3 is a flowchart of an example arrangement of operations for a computer-implemented method for performing metro-level distributed caching.

FIG. 4 is a schematic view of an example computing device that may be used to implement the systems and methods described herein.

Like reference symbols in the various drawings indicate like elements

### DETAILED DESCRIPTION

Some distributed computing systems employ local caching to reduce the computational costs, network costs, and/or latencies associated with accessing a backend database. In some examples, distributed computing systems are used to serve data associated with extremely large or global collections of audio and/or video files. In such systems, each particular computing system (i.e., data server) of the distributed computing system typically implements a local cache that stores data recently and/or frequently accessed by users of each particular computing system.

While local caching has been found to be beneficial, it has been advantageously discovered that users who are geographically near to each other often access the same data (e.g., the same local news stores, videos, songs, etc.). It has also been recognized that geographically nearby data servers typically end up locally caching similar data. Recognizing that the computation costs, network costs, and latencies associated with communicating with geographically nearby data servers may be significantly lower than communicating with a backend database server, implementations herein are directed toward metro-level distributing caching to take advantage of the caches of geographically nearby data servers. In implementations disclosed herein, a data server that does not have a locally cached copy of requested data first contacts a geographically nearby data server for the requested data before a backend database server is contacted. It has been found that metro-level distributed caching can reduce the amount of traffic to/from backend database servers by as much as nearly 60 percent. It has also been found that using the methods and systems disclosed herein across larger geographical areas may result in diminishing gains. Thus, in some implementations, distributed caching is only performed across metropolitan-sized geographic areas.

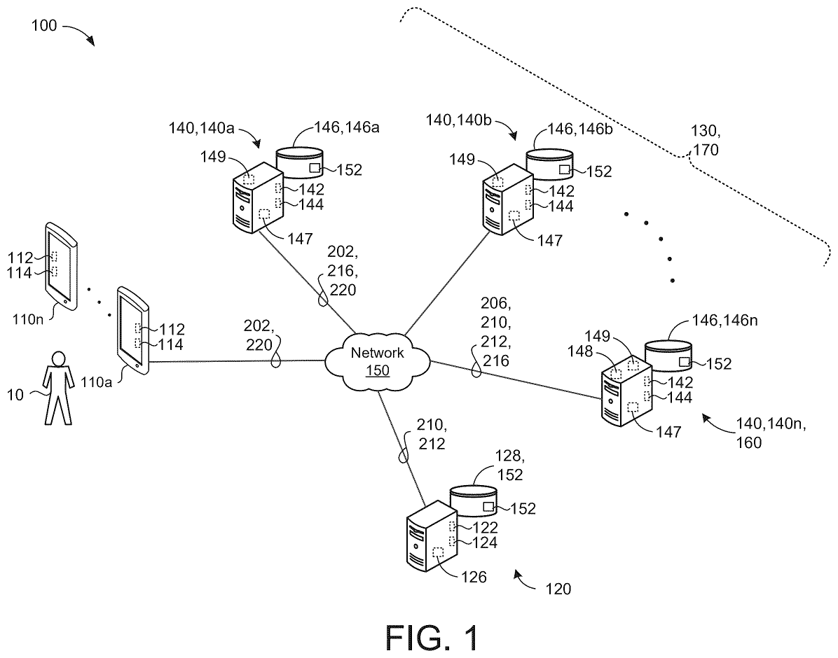

Referring to FIG. 1, an example system 100 includes any number and/or type(s) of user devices 110, 110a-n, a backend database server 120, and a distributed computing system 130. The distributed computing system 130 includes a plurality of computing systems 140, 140a-n (e.g., data servers). The user devices 110, the backend database server 120, and the computing systems 140 are communicatively coupled via a network 150. In the illustrated example, the computing systems 140 are geographically located within a same metropolitan area 170 and are peer computing systems. While only one distributed computing system 130 is shown in FIG. 1, the system 100 may include other distributed computing systems and/or computing systems.

The user devices 110 may correspond to any computing device associated with a user 10 and capable of receiving requests 202 for requested data 152 stored at the backend database server 120 from the user 10 using any number and/or type(s) of user inputs and/or user interfaces. Some examples of user devices 110 include, but are not limited to, mobile devices (e.g., mobile phones, tablets, laptops, etc.), computers, wearable devices (e.g., smart watches), smart appliances, internet of things (IOT) devices, vehicle infotainment systems, smart displays, smart speakers, etc. Each user device 110 includes data processing hardware 112 and memory hardware 114 in communication with the data processing hardware 112 and storing instructions that, when executed by the data processing hardware 112, cause the data processing hardware 112 to perform one or more operations.

The backend database server 120 may be a physical server, a distributed system, or a virtualized system having scalable/elastic resources. The backend database server 120 includes respective physical or virtual computing resources 122 (e.g., data processing hardware) and respective storage resources 124 (e.g., memory hardware) in communication with the computing resources 122 and storing instructions that, when executed by the computing resources 122, cause the computing resources 122 to perform one or more operations. In some examples, the backend database server 120 corresponds to a data center that includes any number and/or type(s) of physical or virtual computing resources 122. The backend database server 120 implements one or more data servers 126 that receive requests for data 152 stored in a backend database 128 from requesting computing systems 140, queries the backend database 128 for the requested data 152, and sends the requested data 152 to the requesting computing systems 140.

The distributed computing system 130 may be a distributed or virtualized system having scalable/elastic resources. Each computing system 140 includes respective physical or virtual computing resources 142 (e g., data processing hardware) and respective storage resources 144 (e.g., memory hardware) in communication with the computing resources 142 and storing instructions that, when executed by the computing resources 142, cause the computing resources 142 to perform one or more operations. In some examples, one or more of the computing systems 140 correspond to a data center that includes any number and/or type(s) of physical or virtual computing resources 142. Each computing system 140 also includes a respective local cache 146, 146a-n for storing data 152 that was recently, or is frequently, requested from the backend database 128.

Each computing system 140 implements one or more local data servers 147 for receiving data requests 202 from the user devices 110. Each data request 202 includes a request for data 152 stored in the backend database 128. In the illustrated example, one of the computing systems (here the computing system 140n) is a designated computing system 160 that will also execute a proxy data server 148 (or cache leader) for implementing a metro-level distributed cache. A non-designated computing system 140 (e.g., the computing system 140a) that does not have a locally cached copy of requested data 152 stored in their respective cache 146, contacts the designated computing system 140n, 160 for the requested data 152 instead of contacting the backend database server 120. If the designated computing system 140n, 160 has a locally cached copy of the requested data 152 in their respective cache 146n, the designated computing system 140n, 160 returns their locally cached copy of the requested data 152 to the non-designated computing system 140. If the designated computing system 140n, 160 does not have a locally cached copy of the requested data 152 in their respective cache 146n, the designated computing system 160 obtains the requested data 152 from the backend database server 120 and then returns the obtained requested data 152 to the non-designated computing system 140.

In some examples, each of the computing systems 140 implements a respective selection module 149. Here, the selection modules 149 are configured to collectively select which computing system 140 will be the designated computing system 160. For example, the designated computing system 160 may be selected randomly, or based on some criteria, such as computing system identifier, a location (geographically and/or relative to other computing systems 140), a network connection speed, an amount of available computing resources, and/or a local cache size. For example, the designated computing system 160 is centrally located relative to the other computing systems 140 or has a larger cache than the other computer systems 140. In some implementations, the selection modules 149 select a new designated computing resource 160 when a previous designated computing resource 160 is no longer responsive. Alternatively, a central resource (e.g., the backend database server 120) may designate a computing system 140 as the designated computing system 160. In some implementations, the central resource drains the local cache 146 of a current designated computing system 160 when, for example, designating a new designated computing system 160. In the following description, the computing system 140n is the designated computing system 160 for the distributed computing system 130.

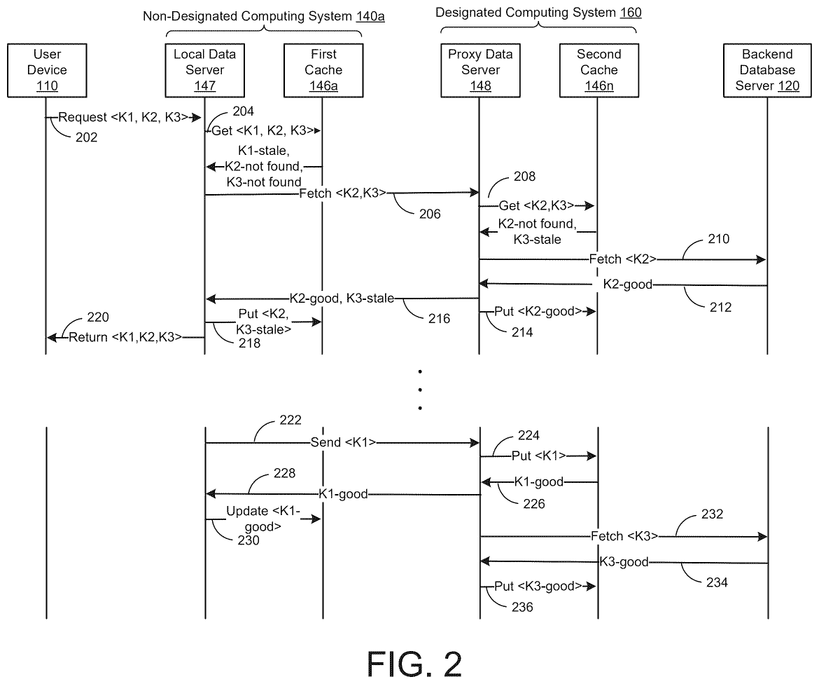

FIG. 2 is a sequence diagram of example operations of the distributed computing system 130 for performing metro-level distributed caching. In the illustrated example, the local data server 147 of the computing system 140a (i.e., a non-designated computing system) receives a first data request 202 from a user device 110, the first data request 202 including a request for data 152 stored in the backend database 128. In the illustrated example, the data 152 includes K1, K2, and K3. In response to the first data request 202, the local data server 147 of the non-designated computing system 140a sends a get command 204 to query a first cache 146a at the computing system 140a to determine whether the data 152 is stored in the first cache 146a. Here, K1 is stored in the first cache 146a but has a status of stale, but K2 and K3 are not stored in the first cache 146a. Based on determining that at least a portion of the requested data (i.e., K1) is stored in the first cache 146a, the local data server 147 obtains K1 from the first cache 146a. Based on determining that at least a portion of the requested data (i.e., K2 and K3) is not stored in the first cache 146a, the local data server 147 sends a second data request 206 to the designated computing system 140n. 160, the second data request 206 including a request for K2 and K3 stored in the backend database 128.

In response to the second data request 206, the proxy data server 148 of the designated computing system 140n, 160 sends a get command 208 to query a second cache 146n at the designated computing system 140n, 160 to determine whether K2 and K3 are stored in the second cache 146n. Here, K3 is stored in the second cache 146n but is stale, and K2 is not stored in the second cache 146n. Based on determining that K3 is stored in the second cache 146n, the proxy data server 148 obtains K3 from the second cache 146n. Based on determining that K2 is not stored in the second cache 146n, the proxy data server 148 sends a third data request 210 to the backend database server 120, the third data request 210 including a request for K2 stored in the backend database 128.

In response to the third data request 210, a data server 126 of the backend database server 120 obtains K2 from the backend database 128. The backend database server 120 returns, in a response 212, K2 to the proxy data server 148.

The proxy data server 148 receives K2 from the backend database server 120 in the response 212 and sends a command 214 to store K2 in the second cache 146n. The proxy data server 148 returns, in a response 216, K2 and K3 to the local data server 147 of the non-designated computing system 140a.

The local data server 147 receives K2 and K3 from the proxy data server 148 in the response 216 and sends a command 218 to store K2 and K3 in the first cache 146a. The local data server 147 sends, in a response 220, the data 152 (i.e., K1, K2, and K3) to the user device 110.

Immediately or at a later time (i.e., asynchronously when, for example, load is low), to help populate the metro-level cache managed by the proxy data server 148, the local data server 147 of the non-designated computing system 140a sends, in a message 222, K1 (which was stale in the first cache 146a) to the proxy data server 148. In response, the proxy data server 148 sends a command 224 to store K1 in the second cache 146n and receives in return a response 226 indicating that K1 is stored in the second cache 146n with a status of Good. The proxy data server 148 sends a response 228 to the local data server 147 indicating that the status of K1 of Good. In response, the local data server 147 sends a command 230 to the first cache 146a to update the status of K1 to Good.

Immediately or at a later time, when the status of data is stale, such as K3 in the example of FIG. 2, the proxy data server 148 sends a fourth data request 232 to the backend database server 120, the fourth data request 232 including a request for the stale data (i.e., K3) stored in the backend database 128. A data server 126 of the backend database server 120 obtains K3 from the backend database 128. The backend database server 120 returns, in a response 234, K3 to the proxy data server 148. Here, K3 now has a status of Good. The proxy data server 148 receives K3 from the backend database server 120 in the response 234 and sends a command 236 to store K3 in the second cache 146n with a status of Good.

Because the operations of the example illustrated in FIG. 2 store K2 in the first cache 146a, when the computing system 140a at a later time receives a data request from a user device 110 for K2, the local data server 147 determines that K2 is stored in the first cache 146a. Based on determining that K2 is stored in the first cache 146a, the local data server 147 may obtain K2 from the first cache 146a, send K2 to the designated computing system 160, and send K2 to the user device 110.

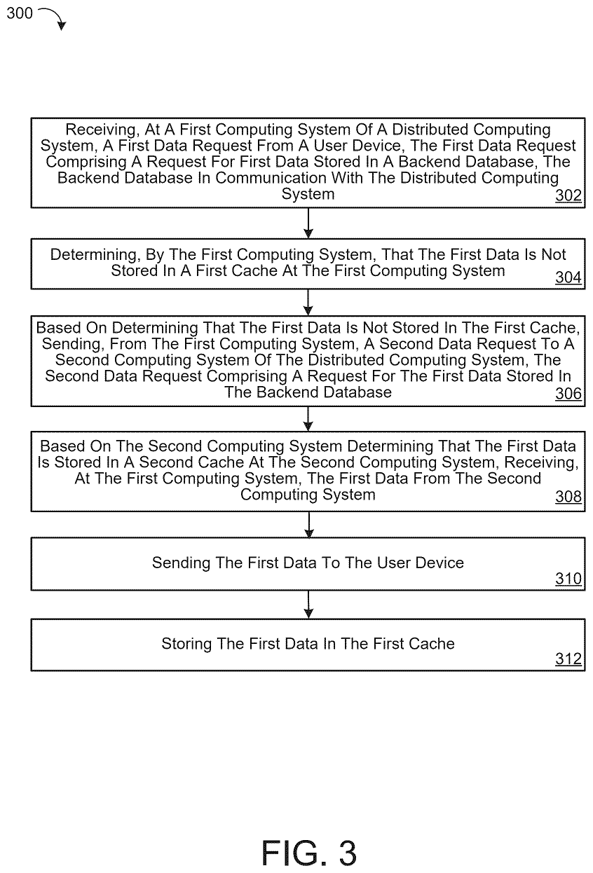

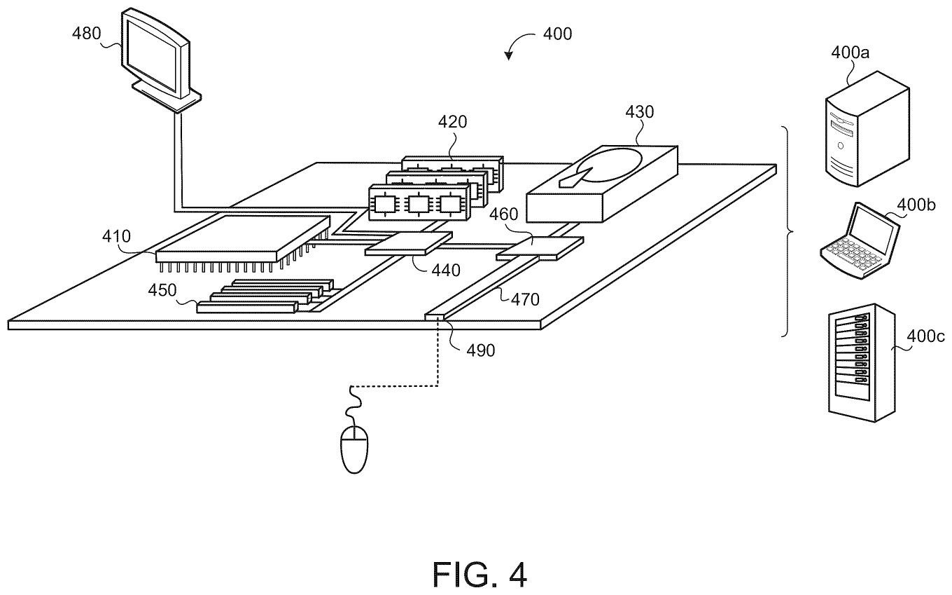

The designated computing system 140n, 160 may likewise receive a data request 202 from a user device 110, the data request 202 including a request for data 152 stored in the backend database 128. In response to this data request, the proxy data server 148 determines whether the data is stored in the second cache 146n at the designated computing system 140n, 160. Based on determining that the requested data 152 is stored in the second cache 146n, the proxy data server 148 obtains the requested data from the cache 146n and sends the requested data 152 to the user device 110. However, based on determining that the requested data 152 is not stored in the second cache 146n, the proxy data server 148 sends a data request 210 to the backend database server 120, the data request 210 including a request for the requested data 152 stored in the backend database 128. In response to the data request 210, the proxy data server 148 receives the requested data 152 from the backend database server 120, stores the requested data 152 in the second cache 146n, and returns the requested data 152 to the user device 110. FIG. 3 is a flowchart of an exemplary arrangement of operations for a computer-implemented method 300 for performing metro-level distributed caching. The operations may be performed by data processing hardware 410 (e.g., the data processing hardware 142 of the computing systems 140) based on executing instructions stored on memory hardware 420 (FIG. 4) (e.g., the memory hardware 144 of the computing systems 140)

At operation 302, the method 300 includes receiving, at a first computing system 140a of a distributed computing system 130, a first data request 202 from a user device 110, the first data request 202 including a request for first data 152 stored in a backend database 128, the backend database 128 in communication with the distributed computing system 130.

At operation 304, the method 300 includes determining, by the first computing system 140a, that the first data 152 is not stored in a first cache 146a at the first computing system 140a. At operation 306, the method 300 includes, based on determining that the first data 152 is not stored in the first cache 146a, sending, from the first computing system 140a, a second data request 206 to a designated computing system 140n, 160 (e.g., a second computing system 140n) of the distributed computing system 130, the second data request 206 including a request for the first data 152 stored in the backend database 128. At operation 308, the method 300 includes, based on the second computing system 140n, 160 determining that the first data 152 is stored in a second cache 146n at the second computing system 140n, 160, receiving, at the first computing system 140a, the first data 152 from the second computing system 140n, 160.

At operation 310, the method 300 includes sending the first data 152 to the user device 110. At operation 312, the method 300 include storing the first data 152 in the first cache 146a.

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 112, 122, and/or 142, memory 420 (i.e., memory hardware) that can be used to implement the memory hardware 114, 124, and/or 144, a storage device 430 (i.e., memory hardware) that can be used to implement the memory hardware 114, 124, and/or 144, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing

device 400 The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400 In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C.

A number of implementations have been described. Nevertheless, it will be understood that various modifications may be made without departing from the spirit and scope of the disclosure. Accordingly, other implementations are within the scope of the following claims.

What is claimed is:

1. A system comprising:
a backend database configured to store data; and
a distributed computing system comprising a plurality of communicatively-coupled computing systems, the plurality of computing systems in communication with the backend database, the plurality of computing systems comprising:
a non-designated computing system; and
a designated computing system, the designated computing system being a peer of the non-designated computing system,
wherein the non-designated computing system is configured to:
receive a first data request from a user device, the first data request comprising a request for first data stored in the backend database;
determine that the first data is not stored in a first cache at the non-designated computing system;
based on determining that the first data is not stored in the first cache, send a second data request to the designated computing system, the second data request comprising a request for the first data stored in the backend database;
receive the first data from the designated computing system;
send the first data to the user device; and
store the first data in the first cache, and
wherein the designated computing system is configured to:
determine that the first data is stored in a second cache at the designated computing system; and
based on determining that the first data is stored in the second cache, send the first data to the non-designated computing system.

2. The system of claim 1, wherein the non-designated computing system is further configured to:
receive a third data request from a second user device, the third data request comprising a request for second data stored in the backend database;
determine that the second data is stored in the first cache; and
based on determining that the second data is stored in the first cache:
send the second data to the designated computing system; and
send the second data to the second user device.

3. The system of claim 1, wherein:
the non-designated computing system is further configured to:
receive a third data request from a second user device, the third data request comprising a request for second data stored in the backend database;
determine that the second data is not stored in the first cache;
based on determining that the second data is not stored in the first cache, send a fourth data request to the designated computing system, the fourth data request comprising a request for the second data stored in the backend database; and
receive the second data from the designated computing system; and
the designated computing system is further configured to:
determine that the second data is not stored in the second cache;
based on determining that the second data is not stored in the second cache, send a fifth data request to a backend database server associated with the backend database, the fifth data request comprising a request for the second data stored in the backend database;
receive the second data from the backend database server; and
send the second data to the non-designated computing system.

4. The system of claim 3, wherein:
the non-designated computing system is further configured to store the second data in the first cache; and
the designated computing system is further configured to store the second data in the second cache.

5. The system of claim 1, wherein the designated computing system is configured to:
receive a third data request from a second user device, the third data request comprising a request for second data stored in the backend database;
determine that the second data is not stored in the second cache;
based on determining that the second data is not stored in the second cache:
send a fourth data request to a backend database server associated with the backend database, the fourth data request comprising a request for the second data stored in the backend database;
receive the second data from the backend database server; and
store the second data in the second cache; and
send the second data to the second user device.

6. The system of claim 1, wherein the designated computing system is further configured to:
receive a third data request from a second user device, the third data request comprising a request for second data stored in the backend database;
determine that the second data is stored in the second cache; and
based on determining that the second data is stored in the second cache, send the second data to the second user device.

7. The system of claim 6, wherein the designated computing system is further configured to refresh a status of the second data in the second cache.

8. The system of claim 1, wherein the plurality of communicatively-coupled computing systems are geographically located within a same metropolitan area.

9. The system of claim 1, wherein each computing system of the plurality of computing systems comprises one or more of:
a physical computing resource;
a virtual computing resource; or
a data center, the data center comprising a plurality of computing resources.

10. The system of claim 1, wherein each computing system of the plurality of computing systems comprises a selection module configured to collectively select a first computing system of the plurality of computing systems as the designated computing system.

11. A computer-implemented method executed on data processing hardware of a distributed computing system that causes the data processing hardware to perform operations comprising:
receiving, at a first computing system of the distributed computing system, a first data request from a user device, the first data request comprising a request for first data stored in a backend database, the backend database in communication with the distributed computing system;
determining, by the first computing system, that the first data is not stored in a first cache at the first computing system;
based on determining that the first data is not stored in the first cache, sending, from the first computing system, a second data request to a second computing system of the distributed computing system, the second data request comprising a request for the first data stored in the backend database;
based on the second computing system determining that the first data is stored in a second cache at the second computing system, receiving, at the first computing system, the first data from the second computing system;
sending, from the first computing system, the first data to the user device; and
storing, by the first computing system, the first data in the first cache.

12. The computer-implemented method of claim 11, wherein the operations further comprise:
receiving, at the first computing system, a third data request from a second user device, the third data request comprising a request for second data stored in the backend database;
determining, by the first computing system, that the second data is stored in the first cache; and
based on determining that the second data is stored in the first cache, sending, from the first computing system:
the second data to the second computing system; and
the second data to the second user device.

13. The computer-implemented method of claim 11, the operations further comprise:
receiving, at the first computing system, a third data request from a second user device, the third data request comprising a request for second data stored in the backend database;
determining, by the first computing system, that the second data is not stored in the first cache; and
based on determining that the second data is not stored in the first cache, sending, from the first computing system, a fourth data request to the second computing system, the fourth data request comprising a request for the second data stored in the backend database,
wherein, when the second data is not stored in the second cache, the second computing system is configured to:
send a fifth data request to a backend database server associated with the backend database, the fifth data request comprising a request for the second data stored in the backend database;
receive the second data from the backend database server; and
send the second data to the first computing system.

14. The computer-implemented method of claim 13, wherein the operations further comprise:
storing, by the first computing system, the second data in the first cache,
wherein the second computing system is configured to store the second data in the second cache.

15. The computer-implemented method of claim 11, wherein the second computing system is further configured to:
receive a third data request from a second user device, the third data request comprising a request for second data stored in the backend database;
determine that the second data is not stored in the second cache;
based on determining that the second data is not stored in the second cache, send a fourth data request to a backend database server associated with the backend database, the fourth data request comprising a request for the second data stored in the backend database;
receive the second data from the backend database server;
store the second data in the second cache; and
send the second data to the second user device.

16. The computer-implemented method of claim 11, wherein the second computing system is further configured to:
receive a third data request from a second user device, the third data request comprising a request for second data stored in the backend database;
determine that the second data is stored in the second cache; and
based on determining that the second data is stored in the second cache, send the second data to the second user device.

17. The computer-implemented method of claim 16, wherein the second computing system is further configured to refresh a status of the second data in the second cache.

18. The computer-implemented method of claim 11, wherein the distributed computing system comprises a plurality of communicatively-coupled computing systems geographically located within a same metropolitan area.

19. The computer-implemented method of claim 11, wherein the distributed computing system comprises a plurality of communicatively-coupled computing systems that includes the first computing system and the second computing system, each computing system of the plurality of computing systems comprising one or more of:
a physical computing resource;
a virtual computing resource; or
a data center, the data center comprising a plurality of computing resources.

20. The computer-implemented method of claim 11, wherein:
the distributed computing system comprises a plurality of communicatively-coupled computing systems that includes the first computing system and the second computing system; and
the operations further comprise selecting the second computing system among the plurality of computing systems as a designated computing system.
